(19) United States
(12) Patent Application Publication
(10) Pub. No.: US 2021/0051449 A1
(43) Pub. Date: Feb. 18, 2021

(54) SYSTEM AND METHOD FOR TALKBURST INITIATOR SELECTION OF TALKGROUP PARTICIPANTS

(71) Applicant: MOTOROLA SOLUTIONS, INC., Chicago, IL (US)

(72) Inventors: KEAN LEE TAN, GELUGOR (MY); CHEE BENG NG, TAIPING (MY); SWEE HAK LAW, BUKIT MERTAJAM (MY)

(21) Appl. No.: 16/537,729

(22) Filed: Aug. 12, 2019

(51) Int. Cl. H04W 4/10

(52) U.S. Cl. CPC H04W 4/10

(57) ABSTRACT

In one aspect, a method for talkburst initiator selection of talkgroup participants is provided. A selection application may receive, from an initiator of a group call destined for a talkgroup, a talkburst associated with a set of rules. The set of rules may specify criteria for selection of participants of the talkgroup that should receive the talkburst. It may be determined which members of the talkgroup satisfy the criteria specified by the set of rules. The talkburst may be sent, wherein only talkgroup members that satisfy the criteria specified by the set of rule output the talkburst.

### BACKGROUND

Radio communications, in particular radio communications in a public safety context, often make use of a concept referred to as a talkgroup. A talkgroup is a group of users that may desire to communicate with each other. When a talkgroup call is initiated, all members of the talkgroup become members of the call. All parties are able to hear the contents of the call.

For example, public safety personnel (e.g. police officers, firemen, emergency medical services) may organize themselves in various talkgroups. One talkgroup may be all police officers within a city. Another talkgroup may be only those police officers assigned to patrol a particular portion of the city. The public safety personnel may be equipped with fixed or mobile radio communications devices, such as Land Mobile Radio (LMR) walkie talkies or broadband devices, such as cellular phones. These devices may be equipped with a push-to-talk (PTT) feature. When a user wishes to communicate with others, he may select a talkgroup and press a PTT button on his deice, which may then initiate a group call to all members of the talkgroup.

Selection of the talkgroup may determine who is part of the group call. In the preceding example, if the talkgroup consisting of all police officers is selected, all officers with the city will participate in the group call. Likewise, if the talkgroup consisting of officers assigned to a particular portion of the city is selected, only those officer will participate in the group call.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an example environment that may implement the talkburst initiator selection of talkgroup participants techniques described herein.

FIG. 2 is an example of a sequence diagram of a network implementing the talkburst initiator selection of talkgroup participants techniques described herein.

FIG. 3 is an example of a sequence diagram of a user device implementing the talkburst initiator selection of talkgroup participants techniques described herein.

FIG. 4 is an example flow diagram of a device implementing the talkburst initiator selection of talkgroup participants techniques described herein.

FIG. 5 is an example flow diagram of a network processing a group call utilizing the techniques described herein.

FIG. 6 is an example of a user device that may implement the techniques described herein.

FIG. 7 is an example of a network system that may utilize the techniques described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Talkgroups are invaluable when it is desired to communicate with a subset of people within an agency, such as a public safety agency. An administrator may, in advance, create a talkgroup with any desired participants. In some systems, the users themselves may create talkgroups without requiring administrator assistance. Selection of a talkgroup determines who will be included in a group call.

Talkgroups are best suited to groups that do not dynamically change within short periods of time. For example, consider the case of a talkgroup including police officers assigned to patrol a particular portion of a city. Although the officers assigned to the portion of the city may change from time to time, it would not be expected that the group would be constantly changing. As another example, an officer assigned to the portion of the city may not currently be on duty (e.g. vacation, in court, etc.), but they are still assigned to patrol the portion of the city. It would not be feasible to create specific talkgroups that take into account dynamic changes to the talkgroup members. For example, it would not be feasible to create a talkgroup consisting of only members that are currently on duty, because the group members on duty may be changing constantly from day to day, or even within a day. In addition, sometimes it may be desirable to send a message to only a select subset of people within the talkgroup (e.g. message should only be sent to people who speak a certain language).

A problem arises in that talkgroups are generally not well suited to dynamic changes in participants. For example, to prevent a talkgroup member from receiving a message, the member may be removed from the talkgroup. However, this does not help in the case where the exclusion was intended to be temporary (e.g. for a specific call). It may be possible to “clone” the talkgroup and remove people from the cloned group. Such a solution may cause extreme growth in the number of talkgroups, as a talkgroup would be needed that includes every possible permutation of members of the organization. In some cases, it may not even be possible to create the talkgroups in advance as knowledge of the membership cannot be known ahead of time. For example, an officer may want to send a message to all other officers assigned to the portion of the city that are within 500 feet of the location of the sending officer. Creation of such a talkgroup could not be done in advance, because each officer's location is not static throughout the day.

The techniques described herein overcome these problems and others, individually and collectively. Upon selection of a talkgroup, the talkburst initiator (e.g. person initiating the group call) may be presented with a menu that allows the talkburst initiator to specify rules for who will be included in the group call. The rules specify criteria for a person to be included in the group call. For example, one rule may be that only those members of the talkgroup that are currently on duty should participate in the group call. The rules specify criteria for inclusion in the group call and do not specify particular members. The overall membership of the talkgroup is not changed.

The rules may be specified in many different ways. Certain default rules may always be present. For example, default rules (e.g. currently on duty, supervisor or above rank, medical knowledge, etc.) may always be presented to the group call initiator. Rules may also be sent from the network. The network may cause rules that are not applicable to not be available for selection. For example, if all members of the talkgroup are currently on duty, there would be no reason to present an “on duty” rule for selection as all members would satisfy that criteria. The network may also send rules that are most useful given the environment in which the system operates. For example, in an environment where multiple languages are spoken, the talk group may send rules allowing the group call initiator to select language proficiency.

Upon receipt of the talkburst by the network, the network may determine which members of the talkgroup satisfy the criteria specified by the rules. This determination may be performed through the use of one or more database lookups. For example, to determine who is currently on duty, a scheduling/time keeping database may be queried to determine members of the talkgroup that are currently scheduled to be on duty and have “clocked in” for their shift. A selection of a rule that specifies prophecy in a particular language can cause the network to query a database to determine which group members are proficient in the specified language.

Once the talkgroup members that are to be include in the group call have been determined, the network ensures that only those members join the group call. In some implementations, where a dedicated channel between the network and the end user is established, the network may simply bypass the connection setup for those members who will not participate in the call. In implementations where a shared channel is used (e.g. simulcast/multicast) an indication is sent to end user that is not to be included in the group call informing the end user to ignore the next communication received over the shared channel, even though the message is directed to a talkgroup that the end user is a member of.

Once the group call is completed, the system reverts to a state where all members of the talkgroup are included. In other words, the exclusion of talkgroup members based on rules is temporary and is applicable for a given group call. Subsequent group calls that do not include rules will revert to including all members of the talkgroup in the group call.

In one aspect, a method for talkburst initiator selection of talkgroup participants is provided. A selection application may receive, from an initiator of a group call destined for a talkgroup, a talkburst associated with a set of rules. The set of rules may specify criteria for selection of participants of the talkgroup that should receive the talkburst. It may be determined which members of the talkgroup satisfy the criteria specified by the set of rules. The talkburst may be sent, wherein only talkgroup members that satisfy the criteria specified by the set of rule output the talkburst.

In one aspect, sending the talkburst further comprises sending the talkburst on a dedicated channel to each talkgroup member that satisfies the criteria specified by the set of rules. In one aspect, sending the talkburst further comprises sending an indication of criteria satisfaction to each determined member of the talkgroup and sending the talkburst on a shared channel to all members of the talkgroup, wherein talkgroup members that did not receive the indication of criteria satisfaction discard the talkburst. In one aspect, determining which members of the talkgroup satisfy the criteria specified by the set of rules further comprises querying at least one database to determine if the criteria specified by the set of rules is satisfied.

In one aspect, the set of rules comprise at least one of talkgroup members that are on duty and talkgroup members that are within a specified area. In one aspect, the set of rules comprise at least one of talkgroup members with domain specific knowledge, talkgroup members with specific skill sets, and talkgroup members with specific language skills. In one aspect, the set of rules comprise talkgroup members that are of a sufficiently high rank.

A system is provided. The system includes a processor and a non-transitory processor readable medium containing a set of instructions thereon. The instructions that when executed by the processor cause the processor to receive, by a selection application, from an initiator of a group call destined for a talkgroup, a talkburst, associated with a set of rules, the set of rules specifying criteria for selection of participants of the talkgroup that should receive the talkburst. The instructions further cause the processor to determine which members of the talkgroup satisfy the criteria specified by the set of rules. The instructions further cause the processor to send the talkburst, wherein only talkgroup members that satisfy the criteria specified by the set of rules output the talkburst.

In one aspect, sending the talkburst further comprises instructions to send the talkburst on a dedicated channel to each talkgroup member that satisfies the criteria specified by the set of rules. In one aspect, sending the talkburst further comprises instructions to send an indication of criteria satisfaction to each determined member of the talkgroup and send the talkburst on a shared channel to all members of the talkgroup, wherein talkgroup members that did not receive the indication of criteria satisfaction discard the talkburst. In one aspect, determining which members of the talkgroup satisfy the criteria specified by the set of rules further comprises instructions to query at least one database to determine if the criteria specified by the set of rules is satisfied.

In one aspect, the set of rules comprise at least one of talkgroup members that are on duty talkgroup members that are within a specified area. In one aspect the set of rules comprise at least one of talkgroup members with domain specific knowledge, talkgroup members with specific skill sets, and talkgroup members with specific language skills. In one aspect, the set of rules comprise talkgroup members that are of a sufficiently high rank.

A method is provided. A talkgroup participant selection function of a communication device may present a set of rules, the set of rules defining criteria for determining members of a talkgroup that are to receive a talkburst. A selection of rules from the set of rules may be received from a user of the communication device. The talkburst and the selected rules may be sent to a communications network, wherein the network uses the selected rules to forward the talkburst to members of the talkgroup that satisfy the criteria for determining members of the talkgroup that are to receive the talkburst.

In one aspect, the set of rules comprise at least one of talkgroup members that are on duty and talkgroup members that are within a specified area. In one aspect, the set of rules comprise at least one of talkgroup members with domain specific knowledge, talkgroup members with specific skill sets, and talkgroup members with specific language skills. In one aspect, the set of rules comprise talkgroup members that are of a sufficiently high rank.

In one aspect the method may further comprise receiving, by the talkgroup participant selection function of a communication device an indication that a second criteria for receiving a second talkburst have not been satisfied, receiving the second talkburst over a shared communications channel, and discarding the second talkburst. In one aspect the method may further comprise receiving, by the talkgroup participant selection function of a communication device an indication that a second criteria for receiving a second talkburst have been satisfied, receiving the second talkburst over a shared communications channel, and outputting the second talkburst.

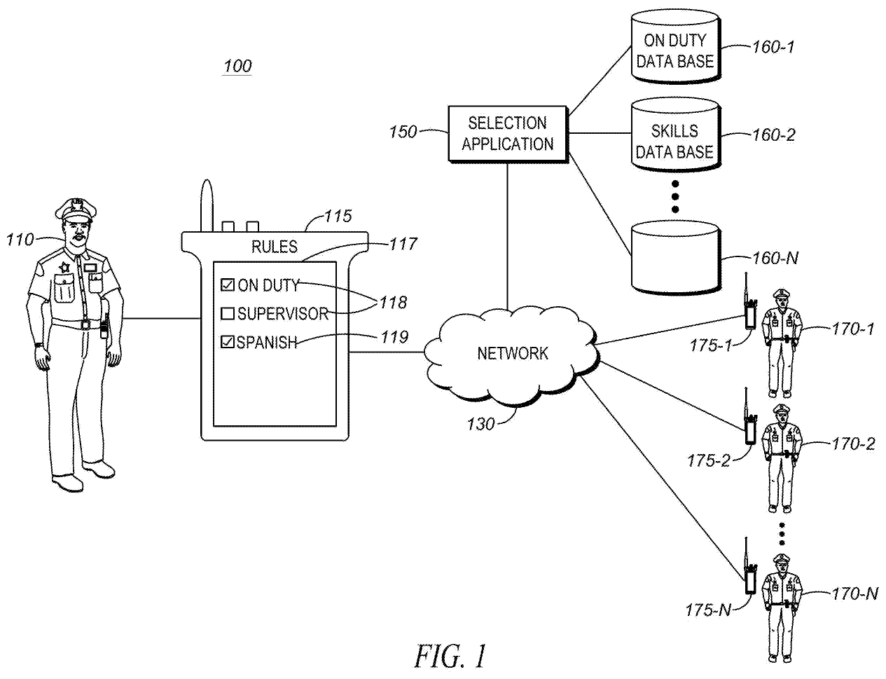

FIG. 1 is a block diagram of an example environment that may implement the talkburst initiator selection of talkgroup participants techniques described herein. Environment 100 may include a group call initiator 110, a network 130, a selection application 150, one or more databases 160-1 . . . n, and one or more talkgroup members 170-1 . . . n.

Group call initiator 110 may possess a communications device 115. The communications device may be a wireless device, such as an LMR walkie talkie or cellular telephone. The communications device may be a fixed position wired device, such as a dispatch console. For ease of description, the remainder of the disclosure is described in terms of wireless devices, but it should be understood that the techniques described herein are equally applicable to wired devices.

Communications device 115 may present a set of rules 117 to group call initiator 110. The rules may specify criteria for selection of members of a talkgroup that will participate in a group call. The rules may be default rules that are always presented to the group call imitator, as they are always applicable. For example, a rule that specifies that members that are on duty or have the rank of supervisor may always be included as rules that can be selected 118. The rules may be rules that are specified ad hoc by the group call initiator. The rules may also be rules that are determined by the selection application 150 and sent to the communications device 115. For example, the selection application 150 may utilize the skills database 160-2 to determine that at least some members of the talkgroup speak Spanish. Thus, the selection application may send a rule to the communications device indicating that at least one member of the talkgroup speaks Spanish 119. It should be understood that the selection application will not send rules to the communications device that would not include any people in the talkgroup. For example, if no members of the talkgroup speak Russian, the selection application would not send Russian as a rule, because there would not be a possibility of anyone in the talkgroup satisfying that rule. The techniques described herein are not limited to any particular source of rules.

The techniques described herein are not restricted to any particular rules. Examples of rules may include, people who are: currently on duty (e.g. not on vacation, on training, etc.), within a specified area/location (e.g. within 500 feet of the group call initiator, near central park, etc.), of sufficiently high rank (e.g. supervisor or greater, etc.), possess domain specific knowledge (e.g. medical training, law training, etc.), specific skills (e.g. hostage negotiation, special weapons training, etc.), language proficiency (e.g. English, Spanish, etc.), experience level (e.g. junior officer, senior officer, etc.), specific physical characteristics (e.g. age, height, gender, etc.), possess specific modes of transport (e.g. car, bike, on foot, off road vehicle, boat, etc.), possess specific tools (e.g. drones, rescue tools, first aid kits, etc.). Although several examples of specific rules have been described, it should be understood that these are only examples. The techniques described herein are not limited to any specific rules or sets of rules.

Environment 100 may also include network 130. Network 130 may allow communications between communications device 115 and talkgroup members 170. Network 130 is not limited to any particular type of network (e.g. LMR network, Tetra network, Broadband network (e.g. Long Term Evolution (LTE) network), 3G network, 4G network, 5G network, etc.). Any network that allows communications between communication device 115 and talkgroup members 170 would be suitable.

Environment 100 may also include selection application 150. The selection application may be integrated within the network 130 or may be coupled to the network as an external application. The selection application may, based on rules received from the communications device 115, determine which talkgroup members 170 satisfy the criteria specified by the rules. In order to determine which talkgroup members satisfy the rules, the selection application may access one or more databases 160-1 . . . n. Some examples of databases may include an on duty database 160-1 (e.g. stores which talkgroup members are currently on duty, etc.), a skills database 160-2 that stores specific skill sets possessed by talkgroup members (e.g. specific language skills, specialized training, etc.).

The selection application may also make use of information provided by the network 130. For example, the network may track the presence/location of each talkgroup member and provide that information to the selection application, which may then use the information when evaluating satisfaction of location based rules.

In addition to evaluating rules, the selection application 150 may be configured to send rules to the communications device 115 to be presented to the group call initiator 110. The rules may be based on information received from the databases 160. For example, if the selection application determines that Spanish is a language spoken by at least one talkgroup member, a rule may be presented that allows the group call initiator to select talkgroup members that speak Spanish.

Environment 100 may also include a plurality of talkgroup members 170-1 . . . n. Each of these talkgroup members may be equipped with a communication device 175-1 . . . n. The communication device may be of a form similar to communications device 115. The particular skills and/or status associated with each talkgroup member 170 may be stored in databases 160, or be accessible to selection application 150 from the network 130. This information may be used by the selection application when selecting talkgroup members to participate in a group call.

In operation, a group call initiator 110 may use communication device 115 to initiate a group call to members of a talkgroup. The communication device may present a list of rules to the user, and the rules may be utilized to determine which members of the talkgroup will participate in the group call. The rules may be default rules that are always present on the device. The rules may be rules that are created by the group call initiator. The rules may have been received from a selection application 150 through a network 130.

The group call initiator 110 may select one or more of the rules. Only talkgroup members that satisfy criteria specified by the selected rules will be included in the group call. The group call initiator may then initiate the group call by sending a talkburst to the network, the talkburst including the selected rules. In one example, the talkburst may include a voice communication from the call initiator, however it should be understood that the talkburst could instead be a data communication.

The talkburst and selected rules may be received by a network 130. The network may utilize a selection application 150 to determine which members of the talkgroup 170 satisfy the criteria specified by the rules. In some cases, the selection application may utilize databases 160 to determine which talkgroup members satisfy the selected rules (e.g. currently on duty, etc.). In some cases, the selection application may utilize network provided information (e.g. current location) to determine if criteria specified by the rule is satisfied. It should be understood that the selection application receives the selected rules, and uses data sources to determine which talkgroup members satisfy the criteria specified by the selected rules. The techniques described herein are not dependent on any particular data source.

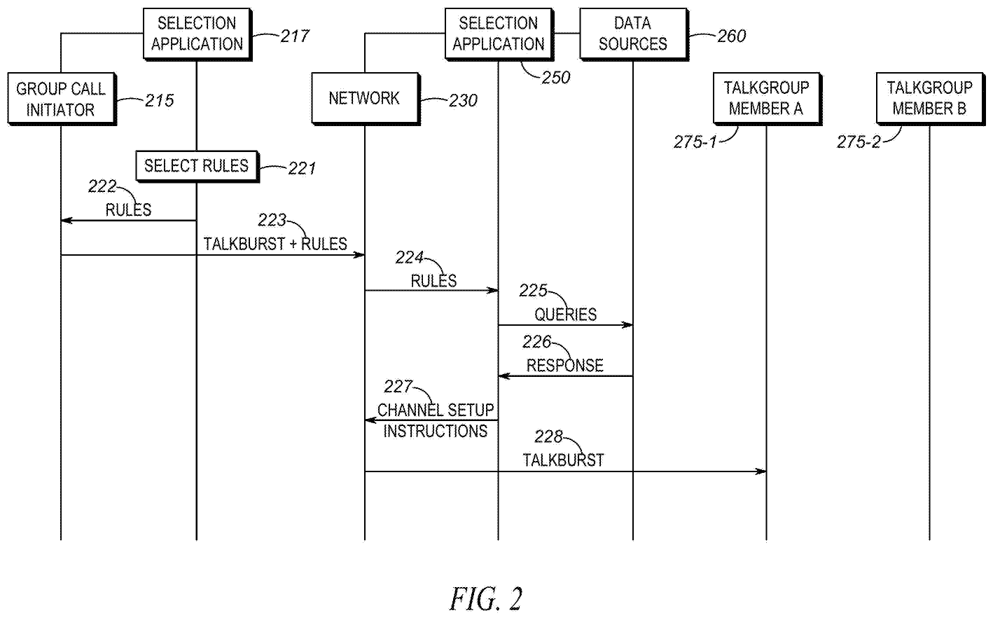

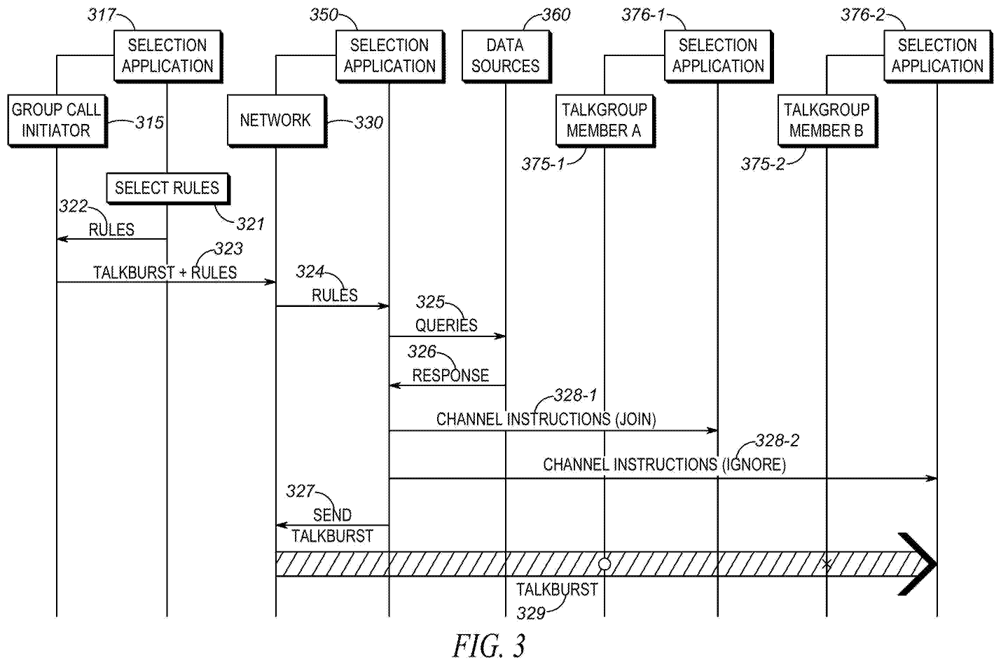

The selection application 150 may then cause the group call to be created between the group call initiator and those members of the talkgroup that satisfy the criteria specified in the selected rules. As will be explained in further detain with respect to FIG. 2, in an implementation that utilizes dedicated network to talkgroup member communications channels, the selection application simply causes the network to not establish communications with talkgroup members that did not satisfy the selected rules. In implementations wherein a shared communications channel is used, the selection application may cause a selection application on the talkgroup member's communication device to ignore any messages for group calls in which the specific talkgroup member did not satisfy the criteria specified by the rules. Such an implementation is described in further detail with respect to FIG. 3.

The group call may then continue with the members that satisfy the criteria specified in the selected rules. It should be understood that the selection of the rules and the exclusion of talkgroup members that do not satisfy the rules is only temporary. No permanent changes are made to the list of members of the talkgroup. Once the specific group call initiated by the group call initiator 110 has completed, any subsequent group call would include all members of the talkgroup (unless the subsequent group call itself included a selection of rules to apply).

FIG. 2 is an example of a sequence diagram of a network implementing the talkburst initiator selection of talkgroup participants techniques described herein. As shown, sequence diagram includes a group call initiator 215. The group call initiator may be a device controlled by a user who wishes to initiate a group call. The group call initiator may be associated with a selection application 217. The selection application may allow the user of the group call device to select rules that will determine which talkgroup members will be included in the group call. The selection application may be a built in part of the user interface for the group call initiating device (e.g. built in to the device) or it may be an add on application (e.g. an app for a smart device).

What should be understood is that the selection application is used by the group call initiator to select which rules will be used for the group call. As explained above, the actual rules may be a set of default rules that are included in the selection application (e.g. rules that are always applicable), rules specified by the user themselves, or rules provided by the network.

The network 230 may be any type of network that allows talkgroup communications. For example, an LMR network or a broadband network. Regardless of the type of network, a PTT functionality may be implemented to allow for PTT communications between members of a talkgroup upon activation of a PTT button by a group call initiator. The network may be coupled to a selection application 250. The selection application may be coupled to one or more data sources 260. The selection application, in conjunction with the data sources may provide several pieces of functionality.

First, as mentioned above, one source of rules for the group call initiator 215 is the network. The selection application 250, in conjunction with the data sources 260 may create rules. For example, the selection application may utilize the data sources 260 to determine languages spoken by members of a talkgroup. Those languages may be presented as rules for selection to the group call initiator. A second piece of functionality that may be provided is the actual evaluation of the rules upon receipt of a talkburst from the group call initiator that includes rules. The selection application, using the data sources, may determine which talkgroup members satisfy the rules specified by the group call initiator.

Finally, the selection application 250 may determine which talkgroup members are included in the group call by selectively establishing connections from the network to the talkgroup members. In FIG. 2, an implementation using a dedicated communications channel between the network 230 and each talkgroup member 275 is described. FIG. 3 describes an implementation in which a shared communications channel is used by all talkgroup members.

In operation, a user may wish to initiate a group call to a talkgroup. The user may select rules 221 to determine which specific rules will be applicable to the selection of members to participate in the group call. For example, as shown in FIG. 1 two rules may be selected. 1. Talkgroup members that are currently on duty and 2. Talkgroup members that speak Spanish. The selected rules may be sent 222 to the group call initiator 215 device. The group call initiator may then send the talkburst (e.g. the communication to be sent to the selected members of the talkgroup) and the rules 223 (e.g. how the specific members of the talkgroup are selected) to the network 230.

The network 230 may utilize selection application 250 in conjunction with data sources 260 to determine which talkgroup members satisfy the selection criteria as specified by the received rules. The rules may be received by the selection application 224. In the present example, one rule that is specified is for talkgroup members that are currently on duty. Data sources that contain this information (e.g. timekeeping data sources, employee scheduling data sources, etc.) may be queried 225 to determine which talkgroup members are currently on duty. Likewise, data sources that contain information about the skills of a talkgroup members may be queried to determine which talkgroup members can speak Spanish. The responses 226 to the queries may be utilized to select the members of the talkgroups that will participate in the group call.

In some cases, information provided by the network itself may be used (not shown). For example, the network may maintain location information for each talkgroup member. If a rule specifying a particular location was selected, location information provided by the network may be utilized to determine which talkgroup members should be included in the group call.

In implementations where a dedicated communications channel is set up between the network and each talkgroup member, the selection application 250 may determine which members of the talkgroup are to be included in the group call and instruct 227 the network 230 to only establish communication channels with the selected members of the talkgroup. For example, in a PTT over cellular system, each member of a talkgroup may have their own dedicated bearer. A member of a talkgroup can be excluded from the group call by simply not setting up the dedicated bearer for that member.

As shown in FIG. 2, assume that talkgroup member A 275-1 is to be included in the group call because the member satisfied the criteria specified in rules 222 while talkgroup member B 275-2 is excluded for not satisfying the rules. The instructions provided by the selection application 250 to the network 230 may indicate to set up a communications channel with talkgroup member A and send the talkburst 228. The instructions may also indicate that no communications channel is to be setup for talkgroup member B, and as such that member will not receive the talkburst and will not be part of the group call.

FIG. 3 is an example of a sequence diagram of a user device implementing the talkburst initiator selection of talkgroup participants techniques described herein. The main elements in FIG. 2 are the same as in FIG. 3 and are similarly numbered. For example, group call initiator 315 is the same as group call initiator 215. The main difference between FIG. 2 and FIG. 3 is that talkgroup member A and B are associated with selection applications 375-1 and 375-2 respectively. Operation of these selection applications will be described in further detail below.

Just as in FIG. 2, the group call initiator may select rules 321 using the selection application 317 and those rules may be received by the group call initiator 322. A talkburst including the rules may be sent 323 to the network 330, which may then utilize selection application 350 and data sources 360 (324, 325, 326) to determine which talkgroup members should be included in the group call. The network may be instructed to send the talkburst 327 to the talkgroup members.

It is at this point that FIG. 3 diverges from FIG. 2. In the sequence diagram of FIG. 3, a shared communications channel is used by all talkgroup members. For example, in the case of a PTT over cellular system, the shared communications channel may be a IP multicast channel, wherein all talkgroup members subscribe to the multicast channel. In an LMR system, the shared communications channel may be a simulcast channel with all talkgroup members monitoring the channel. Because the communications channel that will transmit the talkburst is a shared channel, there is no way to include instructions for each individual talkgroup member to either receive or ignore the talkburst on the shared channel.

The selection application 376-1 and 376-2 may be associated with each talkgroup member. Selection application 376-1, 2 may communicate with selection application 350 over a channel that is separate from the shared channel that is used to send the talkburst. The selection application 350 may send instructions to the talkgroup members to indicate if they should join or ignore the group call associated with the talkburst. For example, in the present example, talkgroup member A satisfies the selection criteria, and is sent channel instructions 328-1 indicating talkgroup member A should join the group call. Talkgroup member B on the other hand is not to join the group call, and as such receives channel instructions 328-2 indicating that talkgroup member should ignore the group call.

The selection application 350 may then instruct the network 330 to send the talkburst 327 on the shared communications channel 329. Because the communications channel is shared, both talkgroup members A and B receive the talkburst. However, based on the previous channel instructions 328, member A knows it is to join the group call, while member B knows it is to ignore the group call.

It should be understood that although selection application 317 and 376-1,2 are described as separate applications with separate functionality, an actual implementation may include both the rules selection functionality, as well as the talkburst join/ignore functionality. When acting as a group call initiator, the rules selection functions may be utilized and when acting as a talkgroup member, the join/ignore functions can be utilized. In alternate implementations, the rules selection functionality may be provided by one application while the join/ignore functionality is provided by a different application. The techniques described herein are not dependent on any particular implementation.

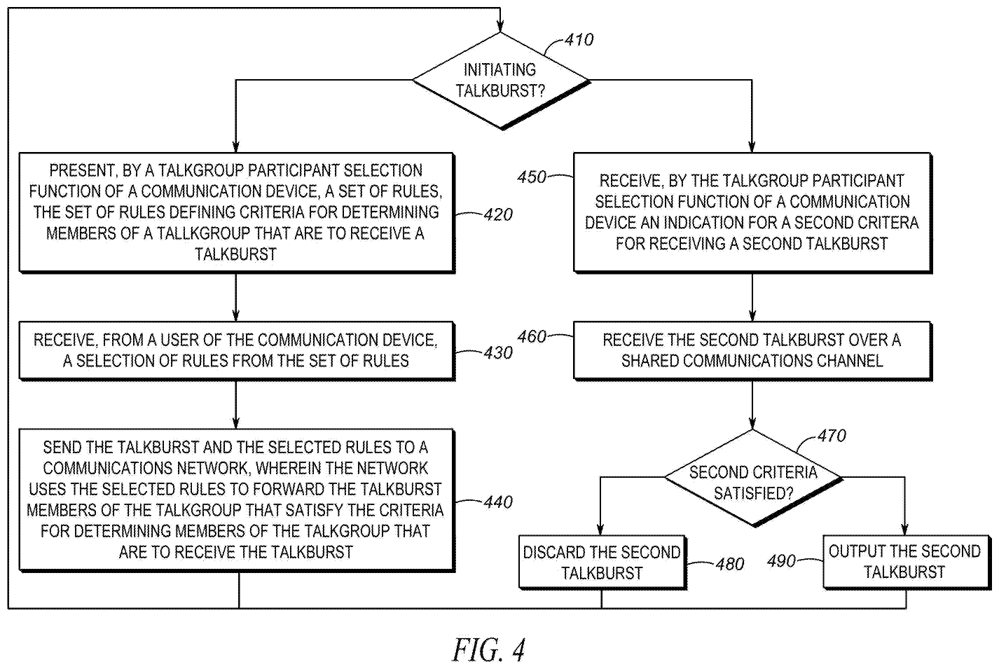

FIG. 4 is an example flow diagram of a device implementing the talkburst initiator selection of talkgroup participants techniques described herein. For example, the flow diagram depicted in FIG. 4 may represent the flow of selection application 317 and 376. In block 410, it may be determined if the device is initiating a talkburst (e.g. selection application 317) or if the device is receiving a talkburst over a shared communications channel (e.g. selection application 376). If the device is initiating a talkburst, the process may move to block 420.

In block 420, a talkgroup participant selection of a communication device may present a set of rules. The set of rules may define criteria for determining members of a talkgroup that are to receive a talkburst. In other words, in block 420, the group call initiator may be presented with a set of rules in order to select which members of the talkgroup will participate in the group call. Examples of such rules (e.g. only those on duty, speak a certain language, etc.) have been presented previously. The talkgroup participant selection function may be a standalone application running on the device of the group call initiator or it may be integrated into the device itself. What should be understood is that the user is presented with a set of rules from which to select.

In block 430 a selection of the set of rules may be received from a user. In other words, the user may specify the members of the talkgroup that will participate in the group call by selecting rules. Only those talkgroup members that satisfy the criteria specified by those rules will be permitted to join the group call.

In block 440, the talkburst and the selected rules may be sent to a communications network. The network may use the selected rules to forward the talkburst to members of the talkgroup that satisfy the criteria for determining members of the talkgroup that are to receive the talkburst. In other words, the rules selected by the user are sent to the network for use in determining which members of the talkgroup are to be included in the group call. The talkburst itself is the communication intended to be sent to the selected talkgroup members. In some cases, that communication may be a group voice call, although the techniques described herein are not limited to voice calls and could also be used with data calls, such as text messages. After completing the talkburst, the process returns to block 410.

If it is determined in block 410 that the device is not initiating the talkburst, the process moves to block 450. In block 450, the talkgroup participant selection function of a communication device may receive an indication for a second criteria for receiving a second talkburst. As explained above, when using a shared communication channel, it is not possible to exclude a member from a talkgroup by not setting up a communications channel, as all members share the same channel. In order to overcome this problem, the talkgroup participant selection function, which may implement the functionality described by selection application 376 may be provided.

In block 460, the second talkburst may be received over a shared communications channel. For example, as described above an IP multicast channel or a LMR talkgroup communications channel. In block 470, it may be determined if the second criteria were satisfied. For example, in block 450, an indication of if the second criteria were or was not me may be received. The result may be evaluated in block 470.

If the second criteria are not satisfied, the process moves to block 480 in which the second talkburst is discarded. In other words, the was a rule selected for participation in the group call, and the indication received in block 450 was that the recipient does not meet the criteria specified for joining the group call. The recipient will still receive the talkburst over the shared channel, but will simply discard it. If it is determined I block 470 that the second criteria are met, the process moves to block 490. In block 490 the second talkburst is output. In other words, a recipient that satisfies the second criteria is included in the group call.

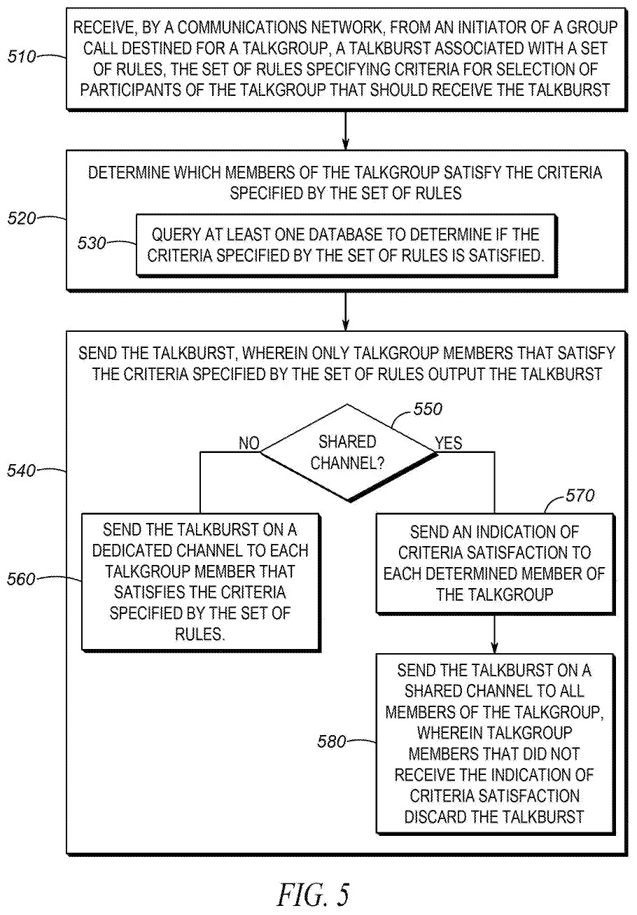

FIG. 5 is an example flow diagram of a network processing a group call utilizing the techniques described herein. For example, the flow diagram depicted in FIG. 5 may represent the flow of selection application 250 and 350. In block 510, a selection application may receive, from an initiator of a group call destined for a talkgroup, a talkburst associated with a set of rules. The set of rules may specify criteria for selection of participants of the talkgroup that should receive the talkburst. In other words, a user may desire to initiate a group call with a subset of members of a talkgroup. The user selects a set of rules that may be used to identify the subset of members, and sends those rules, along with a talkburst (e.g. the communication to be sent to the subset of members) to a selection application.

In block 520, it may be determined which members of the talkgroup satisfy the criteria specified by the set of rules. As mentioned above, the selection application receives the rules, and then may determine which talkgroup members should receive the talkburst based on the rules. One possible way this may be done is by querying a database. In block 530, at least one database may be queried to determine if the criteria specified by the set of rules is satisfied. For example, if the rule specified only on duty talkgroup members should receive the communication, the selection application may query a database associated with a worker time management system (e.g. scheduling system, time clock system) to determine who is currently scheduled to be on duty and has actually clocked in to work.

It should be understood that the selection application may also use data from any other source to determine which members satisfy the set of rules. For example, in some cases, the network may track the location of the members of the talkgroup. If a rule based on distance is received (e.g. talkgroup members within 500 feet of the talkburst initiator) the network may be queried to gather the current location of each member of the talkgroup in order to evaluate the rule.

In block 540, the talkburst may be sent, wherein only talkgroup members that satisfy the criteria specified by the set of rules output the talkburst. In other words, the talkburst may be sent in such a way that only talkgroup members that satisfy the criteria specified by the set of rules actually cause the contents of the talkburst to be played out to the talkgroup member. It should be understood that a talkgroup member may receive the talkburst, but will not cause the contents of the talkburst to be played out if the talkgroup member does not satisfy the rules.

In block 550 it may be determined if a shared communications channel is used. As noted above, some systems may use dedicated communications channels in which each talkgroup member communicates with the network over a communications channel that is not shared with other talkgroup members. For example, in the case of PTT over Cellular, each talkgroup member may have a dedicated bearer channel used for communication with the network.

If a shared communications channel is not used, the process moves to block 560. In block 560, the talkburst may be sent on a dedicated channel to each talkgroup member that satisfies the criteria specified by the set of rules. In other words, because each talkgroup member has a dedicated channel, it is possible to exclude a talkgroup member from the group call by simply not sending that member the talkburst. The non-selected talkgroup members would not necessarily even be aware that a group call with the talkgroup was ongoing and that the non-selected talkgroup members had been excluded.

If it is determined in block 550 that a shared communications channel is in use, the process moves to block 570. As mentioned above, in some systems a shared communications channel is used and all talkgroup members receive all communications over that channel. For example, in a PTT over cellular system that utilizes multicast transmission, all members of the talkgroup would receive all talkbursts. As another example, in an LMR system, all members of the talkgroup would receive and decode all communications that are tagged with the talkgroup ID.

In block 570, and indication of criteria satisfaction may be sent to each determined member of the talkgroup. In other words, once the system determines which talkgroup members satisfy the criteria, an indication may be sent to each of those specific members. This indication may be sent over the shared communications channel or over a dedicated channel. However, what should be understood is that each member that satisfied the criteria receives a specific indication that the criteria was satisfied.

In block 580 the talkburst may be sent on a shared channel to all members of the talkgroup, wherein talkgroup members that did not receive the indication of criteria satisfaction discard the talkburst. In other words, if a talkgroup member does not receive an indication that it has satisfied the criteria for the talkburst, it simply ignores the talkburst (e.g. behaves as if the talkburst was never received). As such, only talkgroup members that satisfy the criteria will be presented with the talkburst contents.

Although block 540 has been described in terms of talkgroup members using either a shared or dedicated communications channel, it should be understood that combinations are also possible (e.g. some users use dedicated channels, other users used shared channels). The shared communications channel process can be applied to users on a shared communications channel while the dedicated communications channel process can be used for those users that utilize dedicated communications channels.

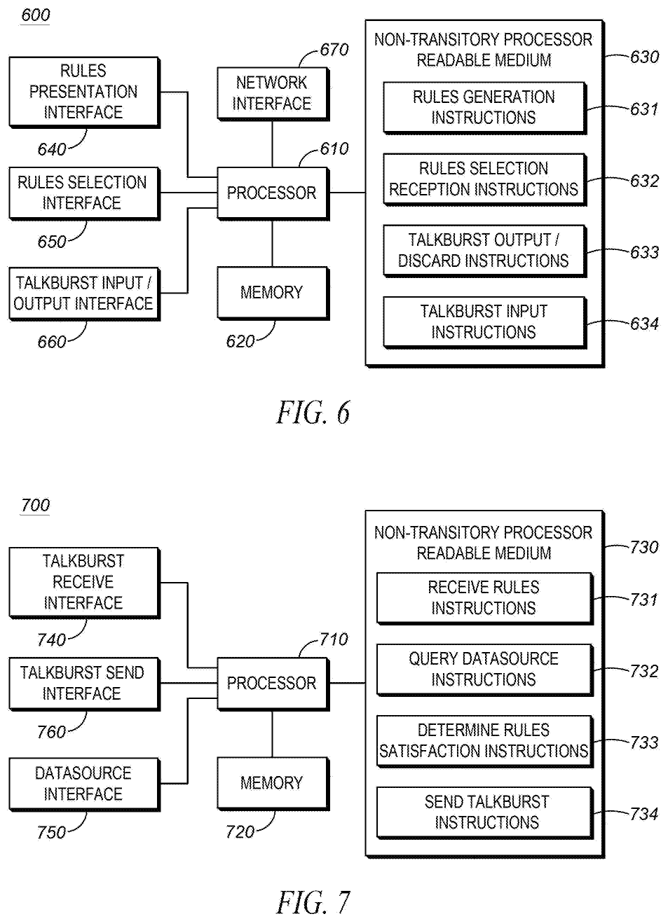

FIG. 6 is an example of a user device that may implement the techniques described herein. It should be understood that FIG. 6 represents one example implementation of a user device that utilizes the techniques described herein. Although only a single processor is shown, it would be readily understood that a person of skill in the art would recognize that distributed implementations are also possible. For example, the various pieces of functionality described above (e.g. rules generation, presentation, selection, etc.) could be implemented on multiple devices that are communicatively coupled. FIG. 6 is not intended to imply that all the functionality described above must implemented on a single device.

Device 600 may include processor 610, memory 620, non-transitory processor readable medium 630, rules presentation interface 640, rules selection interface 650, talkburst input/output interface 660, and network interface 670.

Processor 610 may be coupled to memory 620. Memory 620 may store a set of instructions that when executed by processor 610 cause processor 610 to implement the techniques described herein. Processor 610 may cause memory 620 to load a set of processor executable instructions from non-transitory processor readable medium 630. Non-transitory processor readable medium 630 may contain a set of instructions thereon that when executed by processor 610 cause the processor to implement the various techniques described herein.

For example, medium 630 may include rules generation instructions 631. Rules generation instructions may cause the processor to generate a set of rules for presentation to a user of the device using rules presentation interface 640. The rules presentation interface can be utilized to present the generated rules to the user in any suitable format. In many cases, the rules presentation interface will be a display screen allowing a visual representation of the generated rules. It should be understood that alternative interfaces (e.g. audio interface) may also be used. As mentioned above, rules can come from default rules on the device itself, rules entered by the user, or rules received form the network. The techniques described herein are not dependent on any particular source of the rules.

Medium 630 may include rules selection reception instructions 632. The rules selection reception instructions may utilize rules selection interface to receive a selection of rules that were presented to the user using the rules presentation interface 640. The rules selection interface may include input devices such as keyboards, touch screens, or audio interfaces. Medium 630 may also include talkburst output/discard instructions 633. As explained above, in some cases (e.g. when a shared communications channel is used) the user device determines when to output or discard a received talkburst. Talkburst output/discard instructions may receive a talkburst from the network over network interface 670 and determine that the talkburst should be output. The talkburst may then be output using talkburst input/output interface 660. The output portion of the talkburst input/output interface may include devices such as a speaker for audible output or a display screen for data textual/visual output.

The medium may also include talkburst input instructions 634. Talkburst input instructions may be used to receive a talkburst using talkburst input/output interface 660. The input portion of the talkburst input/output interface may include a microphone for receiving audio communications. The input may also include other inputs, such as a keyboard, keypad, or touch screen input. The talkburst input instructions may cause the device to receive the talkburst and send the talkburst, along with the selected rules, to the network via network interface 670.

Network interface 670 may be an interface to the device to a network. In many cases, the network may be a wireless network, such as an LMR or LTE network. The techniques described herein are applicable to any type of network, both wired or wireless, that is usable with talkgroup based communications.

FIG. 7 is an example of a network system that may utilize the techniques described herein. It should be understood that FIG. 7 represents one example implementation of a network system that utilizes the techniques described herein. Although only a single processor is shown, it would be readily understood that a person of skill in the art would recognize that distributed implementations are also possible. For example, the various pieces of functionality described above (e.g. receiving rules, querying data sources, determining rule satisfaction, sending talkbursts, etc.) could be implemented on multiple devices that are communicatively coupled. FIG. 7 is not intended to imply that all the functionality described above must implemented on a single device.

Network 700 may include processor 710, memory 720, non-transitory processor readable medium 730, talkburst receive interface 740, data source interface 750, and talkburst send interface 760.

Processor 710 may be coupled to memory 720. Memory 720 may store a set of instructions that when executed by processor 610 cause processor 610 to implement the techniques described herein. Processor 710 may cause memory 720 to load a set of processor executable instructions from non-transitory processor readable medium 730. Non-transitory processor readable medium 730 may contain a set of instructions thereon that when executed by processor 710 cause the processor to implement the various techniques described herein.

For example, medium 730 may include receive rules instructions 731. Receive rules instructions may cause the processor to receive a talkburst using talkburst receive interface 740. As mentioned above, the network may receive a talkburst and the talkburst may be associated with a set of rules that were selected by the talkburst initiator. The talkburst receive interface may be a wireless interface to a wireless communications network, such as an LMR or LTE network. The techniques described herein may also be utilized with wired networks.

Medium 730 may also include query data source instructions 732. The query data source instructions may use data source interface 750 to send queries to data sources. The data source interface may allow the processor to send queries over a wired or wireless communications path to one or more databases that may include information usable to evaluate talkgroup members. It should be understood that data source interface 750 may be used to interface with any type of data source, not just databases, that may provide information that can be used to evaluate talkgroup members.

Medium 730 may also include determine rules satisfaction instructions 733. The rules satisfaction instructions may be used to determine which talkgroup members satisfy the criteria specified by the rules received using receive rules instructions 731. The rules satisfaction instructions may utilize data received through the data source interface 750 in response to the query data source instructions 732. The result of the rules satisfaction instructions may be a determination of the members of the talkgroup that should actually receive the talkburst.

Medium 730 may also include send talkburst instructions 734. The send talkburst instructions may use the talkburst send interface 760 to send the talkburst to the talkgroup members identified by the determine rules satisfaction instructions. The talkburst send interface may be a wireless interface to a wireless communications network, such as an LMR or LTE network. The techniques described herein may also be utilized with wired networks. The talkburst send instructions may be utilized, in the case of dedicated talkgroup member communications channels, to decide which channels to establish. In the case of a shared communications channel, the talkburst send instructions may be utilized to inform talkgroup members about which talkburst they should ignore/discard.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed. References to at least one of A and B should be should be interpreted to mean any number of element A alone, any number of element B alone, or any number of both elements A and B.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a compact disc read only memory (CD-ROM), an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (IC) with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
receiving, by a selection application, from an initiator of a group call destined for a talkgroup that has been created in advance, a talkburst, associated with a set of rules, the set of rules specifying criteria for selection of participants of the talkgroup that should receive the talkburst;
determining which members of the talkgroup satisfy the criteria specified by the set of rules; and
sending the talkburst, wherein only talkgroup members that satisfy the criteria specified by the set of rules output the talkburst.

2. The method of claim 1 wherein sending the talkburst further comprises:
sending the talkburst on a dedicated channel to each talkgroup member that satisfies the criteria specified by the set of rules.

3. The method of claim 1 wherein sending the talkburst further comprises:
sending an indication of criteria satisfaction to each determined member of the talkgroup; and
sending the talkburst on a shared channel to all members of the talkgroup, wherein talkgroup members that did not receive the indication of criteria satisfaction discard the talkburst.

4. The method of claim 1 wherein determining which members of the talkgroup satisfy the criteria specified by the set of rules further comprises:
querying at least one database to determine if the criteria specified by the set of rules is satisfied.

5. The method of claim 1 wherein the set of rules comprise at least one of:
talkgroup members that are on duty; and
talkgroup members that are within a specified area.

6. The method of claim 1 wherein the set of rules comprise at least one of:
talkgroup members with domain specific knowledge;
talkgroup members with specific skill sets; and
talkgroup members with specific language skills.

7. The method of claim 1 wherein the set of rules comprise:
talkgroup members that are of a sufficiently high rank.

8. A system comprising:
a processor; and
a non-transitory processor readable medium containing a set of instructions thereon that when executed by the processor cause the processor to:
receive, by a selection application, from an initiator of a group call destined for a talkgroup that has been created in advance, a talkburst, associated with a set of rules, the set of rules specifying criteria for selection of participants of the talkgroup that should receive the talkburst;
determine which members of the talkgroup satisfy the criteria specified by the set of rules; and
send the talkburst, wherein only talkgroup members that satisfy the criteria specified by the set of rules output the talkburst.

9. The system of claim 8 wherein sending the talkburst further comprises instructions to:
send the talkburst on a dedicated channel to each talkgroup member that satisfies the criteria specified by the set of rules.

10. The system of claim 8 wherein sending the talkburst further comprises instructions to:
send an indication of criteria satisfaction to each determined member of the talkgroup; and
send the talkburst on a shared channel to all members of the talkgroup, wherein talkgroup members that did not receive the indication of criteria satisfaction discard the talkburst.

11. The system of claim 8 wherein determining which members of the talkgroup satisfy the criteria specified by the set of rules further comprises instructions to:
query at least one database to determine if the criteria specified by the set of rules is satisfied.

12. The system of claim 8 wherein the set of rules comprise at least one of:
talkgroup members that are on duty; and
talkgroup members that are within a specified area.

13. The system of claim 8 wherein the set of rules comprise at least one of:
talkgroup members with domain specific knowledge;
talkgroup members with specific skill sets; and
talkgroup members with specific language skills.

14. The system of claim 8 wherein the set of rules comprise:
talkgroup members that are of a sufficiently high rank.

15. A method comprising:
presenting, by a talkgroup participant selection function of a communication device, a set of rules, the set of rules defining criteria for determining members of a talkgroup, that has been created in advance, that are to receive a talkburst;
receiving, from a user of the communication device, a selection of rules from the set of rules;
sending the talkburst and the selected rules to a communications network, wherein the network uses the selected rules to forward the talkburst to members of the talkgroup that satisfy the criteria for determining members of the talkgroup that are to receive the talkburst.

16. The method of claim 15 wherein the set of rules comprise at least one of:
talkgroup members that are on duty; and
talkgroup members that are within a specified area.

17. The method of claim 15 wherein the set of rules comprise at least one of:
talkgroup members with domain specific knowledge;
talkgroup members with specific skill sets; and
talkgroup members with specific language skills.

18. The method of claim 15 wherein the set of rules comprise:
talkgroup members that are of a sufficiently high rank.

19. The method of claim 15 further comprising:
receiving, by the talkgroup participant selection function of a communication device an indication that a second criteria for receiving a second talkburst have not been satisfied;
receiving the second talkburst over a shared communications channel; and
discarding the second talkburst.

20. The method of claim 15 further comprising:
receiving, by the talkgroup participant selection function of a communication device an indication that a second criteria for receiving a second talkburst have been satisfied;
receiving the second talkburst over a shared communications channel; and
outputting the second talkburst.
